(19) United States
(12) Patent Application Publication
(10) Pub. No.: US 2012/0014724 A1
(43) Pub. Date: Jan. 19, 2012

(54) INTERMEDIATE TRANSFER MEMBER

(75) Inventors: Daishi Yamashita, Tokyo (JP); Yuichiro Maehara, Tokyo (JP)

(73) Assignee: Konica Minolta Business Technologies, Inc., Tokyo (JP)

(21) Appl. No.: 13/256,610

(22) PCT Filed: Mar. 12, 2010
(86) PCT No.: PCT/JP2010/054197

§ 371 Date: Sep. 14, 2011

(30) Foreign Application Priority Data
Mar. 18, 2009 (JP) 2009-066170

(51) Int. Cl. G03G 15/20

(52) U.S. Cl. 399/308

(57) ABSTRACT

In order to provide a highly durable intermediate transfer member utilized for an electrophotographic image forming apparatus, with which generation of rubbing scratches and cracks is suppressed, and no filming is generated, and a method of manufacturing the intermediate transfer member, disclosed is an intermediate transfer member for an electrophotographic image forming apparatus, possessing a support and provided thereon, an elastic layer and a surface layer in this order, wherein the elastic layer has an elastic modulus of 10-200 MPa, and the thickness thereof is 50 μm to 500 μm.

### TECHNICAL FIELD

The present invention relates to an intermediate transfer member and a method of manufacturing the intermediate transfer member.

### BACKGROUND

As an image forming method used for an image forming apparatus such as a copying machine, a laser printer or the like, known is a transfer technique by which a toner image formed on a photosensitive drum employing a small diameter toner is primarily transferred to an intermediate transfer member, and then, secondarily transferred from the intermediate transfer member to a transfer material (for example, paper).

In addition, in recent years, colorization has been in progress, and specifically in the case of a color image forming apparatus, employing four color toners such as yellow, magenta, cyan and black, high image quality at high speed has been demanded in order to secondarily transfer four color toner images formed by primarily transferring each toner image formed on a photoreceptor to the intermediate transfer member, four colors at the same time, to a transfer member (for example, paper). An intermediate transfer member belt employing an endless belt for a substrate, and an intermediate transfer member roll employing a metal roll for the substrate are known as the intermediate transfer member.

In the case of a transfer system, the following items are known as typical items to achieve high image quality at high speed with an intermediate transfer member.

(1) A high transfer ratio of a toner image formed via transfer from a photoreceptor onto the intermediate transfer member, into a transfer material, is demanded.

The transfer ratio of means a transfer ratio of a toner image formed on the intermediate transfer member surface, to a transfer material. When the transfer ratio is low, defects appear in the image transferred onto the transfer material, resulting in generation of density unevenness, whereby no high image quality can be realized.

(2) High durability of an intermediate transfer member is demanded.

The durability is referred to as performance transferable onto a transfer material for a long duration. Since the surface of a intermediate transfer member is rubbed with a cleaning blade to eliminate the remaining toner for cleaning after secondary transfer to a transfer material (for example, paper or the like), the surface reduces a surface-smoothness via contact with a cleaning blade, and toner images can not be stably transferred from the photoreceptor because of generation of cracks. In addition, in the case of an endless belt used as an intermediate transfer member, cracks (break) are produced because of pulling.

(3) No generation of filming is demanded.

“Filming” means a phenomenon in which the surface of an intermediate transfer member is cleaned by a cleaning blade after secondary transfer to a transfer material, but the remaining toner which is not removed from the surface is gradually built up. 1) The toner is penetrated into cracks generated on the surface of an intermediate transfer member. 2) The toner remaining in concave portions generated on the surface by being brought into contact with a cleaning blade is left over. The transfer ratio drops in the place where filming has been generated, whereby image streaks and unevenness are generated, resulting in no appearance of high image quality. Further, in recent years, low temperature fixing toner has been used in view of energy conservation. Since the low temperature fixing toner has a low glass transition temperature, filming is easily generated, and there has appeared a critical problem such as generation of filming. The transfer ratio drops in the place where filming has been generated, whereby problems such as image streaks and unevenness are produced.

Since an intermediate transfer member raises a transfer ratio at a time where a toner image formed on a photoreceptor, and a toner image formed on the surface of the intermediate transfer member is transferred to a transfer material (paper, for example) to evenly transfer the toner image, a step to prevent concentrating load is taken in order to prevent image-patch generated by applying the concentrating load to a toner image.

The step to prevent concentrating load produces an effect for not only stress distribution to an intermediate transfer member surface during cleaning with a cleaning blade, but also distribution of stress applied to an intermediate transfer belt during pulling-around of the intermediate transfer belt.

As to the step to prevent concentrating load, in the case of an intermediate transfer belt, for example, known is a method to use an elastic body for a substrate and provide an elastic layer on a substrate, and in the case of an intermediate transfer member roll, and also known is another method to provide an elastic layer on a substrate.

A great deal of studies has been done with respect to (1)-(3) demanded to an intermediate transfer member. For example, when an elastic layer is provided on the outer-circumference of a resin substrate, and a surface layer having a thickness of 10-50 nm, and having a Young's modulus of 0.1-5.0 GPa is provided, wherein Young's modulus of the surface layer has 0.0-2.0 GPa larger than that of the elastic layer, known is an intermediate transfer member capable of obtaining a high quality toner image in which excellent secondary transferability and an excellent cleaning property are maintained, no lack of line image in the text image, together with excellent text reproduction is observed, even though printing a large number of copies (for example, 160000 copies) (refer to Patent Document 1, for example).

It was found out that an intermediate transfer member disclosed in Patent Document 1 exhibited excellent resistance to rubbing scratches on the surface layer, caused by a cleaning blade, but in cases where the intermediate transfer member was a belt, filming as well as lack of line image in the text image was generated when using it for a long duration.

In such a situation, it is desired that developed is a highly durable intermediate transfer member used for an electrophotographic system image forming apparatus exhibiting high transfer efficiency and high durability together with no generation of cracks, no surface deterioration caused by a cleaning blade and no generation of filming during use for a long duration.

### PRIOR ART DOCUMENT

### Patent Document

Patent Document 1: International Publication WO 08/146,743

### DISCLOSURE OF THE INVENTION

### Problems to be Solved by the Invention

The present invention has been made on the basis of the above-described situation, and it is an object of the present invention to provide a highly durable intermediate transfer member utilized for an electrophotographic image forming apparatus, with which generation of rubbing scratches and cracks is suppressed, and no filming is generated.

### Means to Solve the Problems

The above-described object of the present invention is accomplished by the following structures.

(Structure 1) An intermediate transfer member for an electrophotographic image forming apparatus, comprising a support and provided thereon, an elastic layer and a surface layer in this order, wherein the elastic layer has an elastic modulus of 10-200 MPa, and a thickness of 50-500 μm.

(Structure 2) The intermediate transfer member of Structure 1, wherein the surface layer has a hardness of 0.2-10 GPa, an elastic modulus of 1.0-50 GPa, a thickness of 100-1000 μm, and a ratio of an elastic modulus of the surface layer to another elastic modulus of the elastic layer is 10-5000.

(Structure 3) The intermediate transfer member of Structure 1 or 2, wherein the surface layer comprises two layers composed of a lower layer and an upper layer, the lower layer having a hardness of 0.2-2.0 GPa, an elastic modulus of 1.0-10.0 GPa and a thickness of 100-1000 μm, the upper layer adjacent to the lower layer, having a hardness of 2.0-10.0 GPa, an elastic modulus of 10.0-50.0 GPa and a thickness of 10-50 nm.

(Structure 4) The intermediate transfer member of any one of Structures 1-3, wherein the elastic layer comprises a layer formed of at least one selected from the group consisting of chloroprene rubber, nitrile rubber, styrene-butadiene rubber, silicone rubber, urethane rubber and an ethylene-propylene copolymer.

(Structure 5) The intermediate transfer member of any one of Structures 1-4, wherein the substrate comprises at least one selected from the group consisting of polyimide, polycarbonate, polyphenylene sulfide and polyethylene terephthalate.

(Structure 6) The intermediate transfer member of any one of Structures 1-5, wherein the surface layer comprises an inorganic compound, the inorganic compound comprising at least one selected from the group consisting of metal oxide, metal nitride and metal oxide-nitride.

(Structure 7) The intermediate transfer member of Structure 6, wherein the inorganic compound comprises metal oxide, metal nitride or metal oxide-nitride formed from at least one selected from the group consisting of Al, Si and Ti.

(Structure 8) The intermediate transfer member of Structure 6, wherein the inorganic compound is silicon oxide or silicon oxide comprising a carbon.

(Structure 9) The intermediate transfer member of any one of Structures 1-8, wherein the surface layer comprises a layer formed via an atmospheric pressure plasma CVD method.

After considerable effort during intensive studies for utilizing an intermediate transfer member possessing a resin substrate and provided on the outer circumference of the substrate, an elastic layer and an inorganic compound layer as a surface layer, the inventors have found the following out. Each of filming and bleeding at a time when the intermediate transfer member possessing a resin substrate and provided on the outer circumference of the substrate, an elastic layer and an inorganic compound layer as a surface layer is used for a long duration presumably appears to be caused by cracks generated in the inorganic compound layer. Further, the lack of line image in the text image generated specifically in an endless belt-shaped intermediate transfer member presumably appears to be caused by hardness of the intermediate transfer member.

After further studies done to find out why cracks are generated, it was found out that generation of cracks was originated by concentrating stress caused by pressing of a cleaning blade after transfer thereof in the case of an intermediate transfer member in the form of a roll. It was found out that cracks were generated because of repetition of concentrating stress caused by a cleaning blade and bending stress caused by puling-around in the case of an endless belt-shaped intermediate transfer body.

It was confirmed that the lack of line image in the text image, generated in an endless belt-shaped intermediate transfer member was produced since paper following capability with respect to deformation of the inorganic compound layer caused by expansion and contraction of the endless belt during pulling-around was insufficient. In addition, the paper following capability is referred to as belt adherence and toner transferability to the surface-roughness paper sheet.

In order to improve resistance to cracks, hardness of the inorganic compound layer should be increased. In order to improve the paper following capability, the conflicting measure is to be taken since hardness of the inorganic compound layer should be lowered. The measure to increase hardness of the inorganic compound layer is effective to concentrating stress, but it is not advantageous to bending stress, resulting in appearance of weal resistance to cracks, whereby it does not become effective to the paper following capability with respect to deformation of the inorganic compound layer caused by expansion and contraction of the endless belt during pulling-around.

After the measure by which resistance to concentrating stress, resistance to bending stress, and improvement in paper following capability are simultaneously provided to the inorganic compound layer was further studied, it was confirmed that it was effective to disperse stress applied to the inorganic compound layer in the film thickness direction of the elastic layer.

It was found out that it is effective to make a balance between hardness and thickness of the elastic layer to fall within a certain range, whereby resistance to concentrating stress, resistance to bending stress and improvement of paper following capability can be simultaneously provided, and the objective and effect of the present invention can be achieve to accomplish the present invention.

### Effect of the Invention

A highly durable intermediate transfer member utilized for an electrophotographic image forming apparatus, with which generation of rubbing scratches and cracks is suppressed, and no filming is generated can be provided, and a method of manufacturing the intermediate transfer member can also be provided.

### BRIEF DESCRIPTION OF THE DRAWINGS

FIG. 1 is a schematic cross-sectional diagram showing an example of an electrophotographic image forming apparatus in which an intermediate transfer belt is used as an intermediate transfer member.

FIG. 2 is a schematic cross-sectional diagram showing another example of an electrophotographic image forming apparatus in which an intermediate transfer belt is used as an intermediate transfer member.

FIG. 3 is an enlarged schematic cross-sectional diagram of an intermediate transfer belt as an intermediate transfer member as shown in FIG. 1.

FIG. 4 is a schematic diagram of a manufacturing apparatus equipped with an intermediate transfer belt as a belt-shaped intermediate transfer member, with which an inorganic compound layer is formed by an atmospheric plasma CVD method.

### DESCRIPTION OF TILE PREFERRED EMBODIMENTS

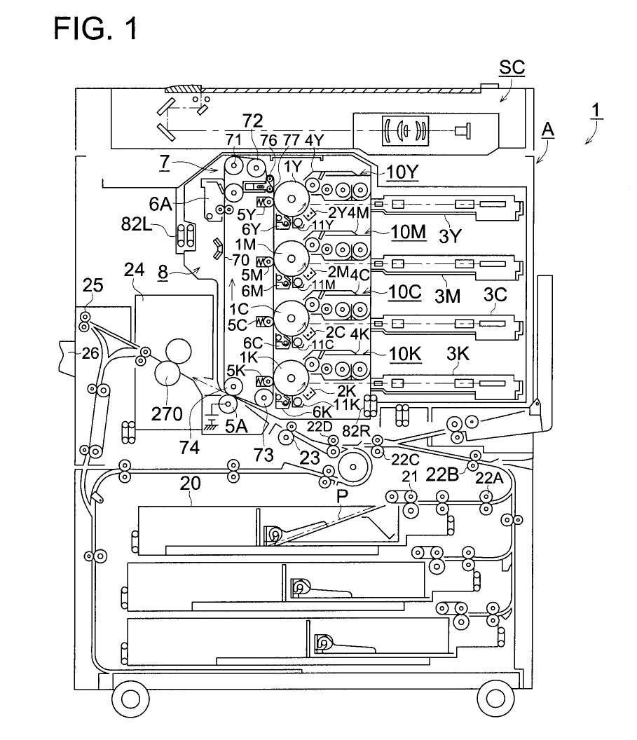

The embodiments of the present invention will be described referring to FIG. 1-FIG. 4, but the present invention is not limited thereto.

FIG. 1 is a schematic cross-sectional diagram showing an example of an electrophotographic image forming apparatus in which an intermediate transfer belt is used as an intermediate transfer member. This figure shows an apparatus utilized as a full-color image forming apparatus.

In FIG. 1, numeral 1 represents a full-color image forming apparatus. Full-color image forming apparatus 1 is equipped with plural image forming units 10Y, 10M, 10C and 10K, endless belt-shaped intermediate transfer member forming unit 7 as a transfer section, endless belt shaped paper supply and conveyance device 21 which conveys recording medium P, and belt-system fixing device 24 as a fixing device. Document image reading device SC is placed on top of main body A of full-color image forming apparatus 1.

As a toner image of a different color formed on each of photoreceptors 1Y, 1M, 1C and 1 K, image forming unit 10Y to form an image of yellow is equipped with drum-shaped photoreceptor 1Y as the first image carrier, charging device 2Y placed around photoreceptor 1Y, exposure device 3Y, developing device 4Y, primary transfer roller 5Y as a primary transfer device and cleaning device 6Y.

Further, as a toner image of another different color, image forming unit 10M to form an image of magenta is equipped with drum-shaped photoreceptor 1M as the first image carrier, charging device 2M placed around photoreceptor 1M, exposure device 3M, developing device 4M, primary transfer roller 5M as a primary transfer device and cleaning device 6M.

Further, as a toner image of another different color, image forming unit 10C to form an image of cyan is equipped with drum-shaped photoreceptor 1C as the first image carrier, charging device 2C placed around photoreceptor 1C, exposure device 3C, developing device 4C, primary transfer roller 5C as a primary transfer device and cleaning device 6C.

Further, as a toner image of another different color, image forming unit 10K to form an image of black is equipped with drum-shaped photoreceptor 1K as the first image carrier, charging device 2K placed around photoreceptor 1K, exposure device 3K, developing device 4K, primary transfer roller 5K as a primary transfer device and cleaning device 6K.

Endless belt-shaped intermediate transfer member unit 7 wound by plural rollers has endless intermediate transfer belt 70 as the second image carrier in the form of a semi-conductive endless belt which is rotatably supported.

An image of each of colors formed from image forming units 10Y, 10M, 10C and 10K is successively transferred onto rotatable endless intermediate transfer belt 70 by primary transferring rollers 5Y, 5M, 5C and 5Bk to form a synthesized color image. Recording medium P such as a paper sheet as a recording medium stored in paper supply cassette 20 is supplied by paper supply and conveyance device 21, and conveyed to secondary transfer roller 5A as the secondary transfer device through plural intermediate rollers 22A, 22B, 22C, 22D and registration roller 23 to transfer color images on recording medium P all together.

Recording medium P onto which color images are transferred is fixed by fixing device 24 fitted with heat roller fixing device 270 and nipped with paper-ejection rollers 25 to place it on paper-ejection tray 26 outside the apparatus.

After transferring color images onto recording medium P by secondary transfer roller 5A, the toner remaining on endless belt intermediate transfer member 70 obtained via self stripping of recording medium P is removed by cleaning device 6A.

Primary transfer roller 5K is constantly pressed against photoreceptor 1K during an image formation process. Each of other primary transfer rollers 5Y, 5M and 5C is pressed against each of corresponding photoreceptors 1Y, 1M and 1C, only during color image formation.

Secondary transfer roller 5A is pressed against endless belt-shaped intermediate transfer member 70, only when secondary transferring is carried out while passing through recording medium P.

Enclosure 8 is possible to be drawn out through supporting rails 82L and 82R from main body A of the apparatus. Enclosure 8 possesses image forming units 10Y, 10M, 10C and 10K, and endless belt-shaped intermediate transfer member unit 7.

Image forming units 10Y, 10M, 10C and 10K are serially placed in the perpendicular direction. Endless belt-shaped intermediate transfer unit 7 is placed on the left side of each of photoreceptors 1Y, 1M, 1C and 1K in the figure. Endless belt-shaped intermediate transfer unit 7 wound by rollers 71, 72, 73, 74 and 76 possesses rotatable endless intermediate transfer belt 70, primary transfer rollers 5Y, 5M, 5C and 5K, and cleaning device 6A.

Image forming units 10Y, 10M, 10C and 10K and endless belt-shaped intermediate transfer unit 7 are drawn out together by drawing enclosure 8 from main body A.

As described above, after charging the circumferential surface of each of photoreceptors 1Y, 1M, 1C and 1K to be exposed to light, and forming a latent image on the circumferential surface, each of toner images is formed via development (image visualization), and the toner images of each color are superposed on endless belt-shaped intermediate transfer member 70 to transfer them onto recording medium P all together and fix them via application of pressure and heat employing belt-system fixing device 24. In addition, “during image formation” described in the present invention means inclusion of latent image formation, and toner image (image visualization) transferred onto recording medium P to form the final image.

Photoreceptors 1Y, 1M, 1C and 1K after transferring the toner image onto recording medium P are moved to cycles of electrification, light exposure and development to conduct the next image formation, after cleaning the toner remaining on the photoreceptor during transfer employing cleaning devices 6A, 6M, 6C and 6K.

In the above-described color image forming apparatus, an elastic blade is utilized as a cleaning member for cleaning device 6A to clean an intermediate member. Coating devices 11Y, 11M, 11C and 11K to coat a fatty acid metal salt are provided in each of photoreceptors. In addition, the same kind as used for the toner can be used as the fatty acid metal salt.

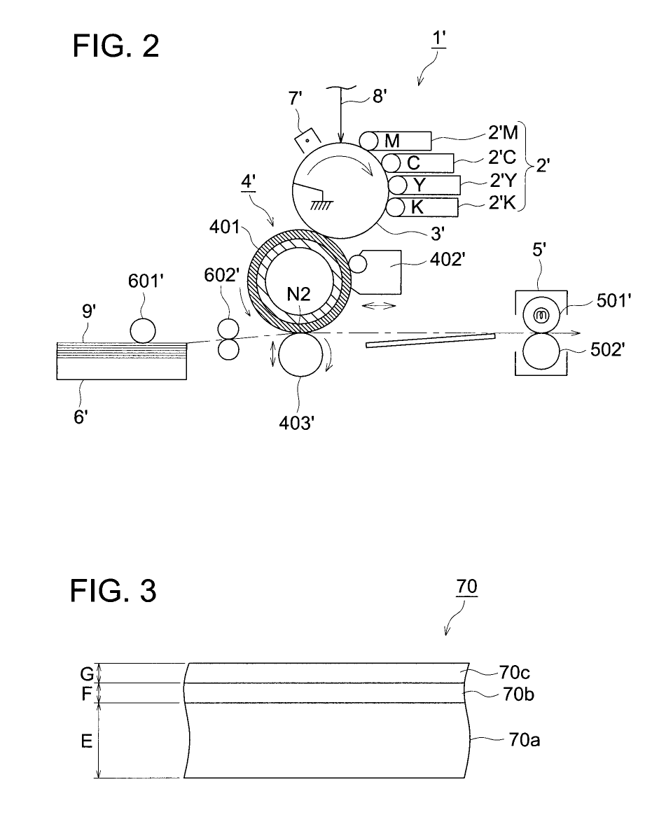

FIG. 2 is a schematic cross-sectional diagram showing another example of an electrophotographic image forming apparatus in which an intermediate transfer belt is used as an intermediate transfer member.

In the figure, 1′ represents a full-color image forming apparatus. Full-color image forming apparatus 1′ is equipped with developing unit 2′, photoreceptor 3′, transfer unit 4′, fixing device 5′ and paper-feeding cassette 6′. Developing unit 2′, equipped with magenta developing unit 2′M possessing magenta toner M, cyan developing unit 2′C possessing cyan toner C, yellow developing unit 2′Y possessing yellow toner Y, and black developing unit 2′K possessing black toner K, is placed around photoreceptor 3′.

Photoreceptor 3′ is placed so as to be rotatably driven at the predetermined circumferential speed in the arrow direction. Photoreceptor 3′ is subjected to an evenly charging treatment so as to obtain the predetermined polarity•potential by a primary charging device (corona charging device) 7′ provided around photoreceptor 3′, and is subsequently subjected to imagewise light exposure 8′ employing an imagewise light exposure device (unshown in the figure) to form the first color component image as an intended color image, for example, an electrostatic latent image corresponding to a magenta component image. Next, the electrostatic latent image is developed with magenta toner M as the first color by magenta developing unit 2′M.

Transfer unit 4′ is equipped with intermediate transfer roller 401′, intermediate transfer roller cleaner 402 and transfer roller 403. Intermediate transfer roller 401′ is designed to be rotatably driven at the same circumferential speed as that of photoreceptor 3′ in the direction opposite to photoreceptor 3′ in the arrow direction in the figure).

The magenta toner image as the above-described first color formed and carried on photoreceptor 3′ is intermediately transferred in order onto the circumferential surface of intermediate transfer roller 401′ with an electric field formed by a primary transfer bias applied from a power supply (unshown in the figure) to intermediate transfer roller 401′ in the process of passing through nip portion N1 (primary transfer section) between photoreceptor 3′ and intermediate transfer roller 401′.

The surface of photoreceptor 3′ obtained by having transferred a magenta toner image as the first color with respect to intermediate transfer roller 401′ is cleaned by s cleaning device (unshown in the figure) provided around photoreceptor 3′. Next, similarly, a cyan toner image as the second color, a yellow toner image as the third color and a black toner image as the fourth color are sequentially formed, and these toner images are sequentially transferred and superimposed on intermediate transfer roller 401′ to layer toner images of from the first color to the fourth color on intermediate transfer roller 401′, resulting in formation of synthetic color toner images with respect to intended color images.

As to transfer (secondary transfer) of the synthetic color toner image transferred via superimposition on intermediate transfer roller 401′, to transfer material 9′, transfer roller 402′ having been separated so far is brought into contact with intermediate transfer roller 401′ by a shifting device (unshown in the figure), and one piece of transfer material 9′ is separately fed from paper-feeding cassette 6′ by paper-feeding roller 601′ and fed to contact nip portion N2 between intermediate transfer roller 401′ and transfer roller 403′ by registration roller 602′ on the predetermined timely basis, and a secondary transfer bias is applied to transfer roller 403′ from bias power supply (unshown in the figure) at the same time. The synthetic color toner image is transferred to transfer material 9′ from intermediate transfer roller 401′ by this secondary transfer bias.

Transfer material 9′ to which the synthetic color toner image is transferred is separated from intermediate transfer roller 401′, and introduced into fixing device 57 by a guide to conduct heat-fixing with heat roller 501′ and pressure-application roller 502′.

After completion of transfer of a synthetic color toner image to transfer material 9′, transferred toner remaining on intermediate transfer roller 401′ is removed by intermediate transfer roller cleaner 402′ being brought into contact with intermediate transfer roller 401′.

In the present invention, the intermediate transfer member means endless intermediate transfer belt 70 shown in FIG. 1, and means intermediate transfer roller 401′ shown in FIG. 2. The present invention relates to endless intermediate transfer belt 70 shown in FIG. 1, and intermediate transfer roller 401′ shown in FIG. 2.

FIG. 3 is an enlarged schematic cross-sectional diagram of an intermediate transfer belt as an intermediate transfer member as shown in FIG. 1.

In the figure, numeral 70 represents an intermediate transfer belt. The intermediate transfer belt has a structure in which elastic layer 70b and surface layer 70c are layered in order on endless belt-shaped substrate 70a.

Substrate 7a preferably has a hardness of 1-15 GPa in consideration of mechanical strength, image quality, manufacturing cost and so forth.

Substrate 70a preferably has a thickness E of 50-1000 μm in consideration of mechanical strength, image quality, manufacturing cost and so forth.

Elastic layer 70b has an elastic modulus of 10-200 MPa. In the case of an elastic modulus of less than 10 MPa, since the elastic layer is too soft, the foregoing range is undesirable in view of degradation of durability, filming, image quality and so forth. In the case of an elastic modulus of more than 200 MPa, since the elastic layer is too hard, this range is undesirable in view of degradation of durability, filming, image quality and so forth.

The elastic layer means a softening layer provided between the substrate and the surface layer. The following two items are provided as main functions for the elastic layer. (1) Since toner remaining on the surface of an intermediate transfer belt (intermediate transfer member) during or after transferring toner images, the first one is a toner-removing function to improve durability of the surface layer by distributing concentrating stress caused by pressing of a blade, and to avoid image defects caused by uneven removal of toner. (2) The second one is a transfer-improving function to evenly transfer onto the surface of an intermediate transfer belt (intermediate transfer member).

Elastic layer 7b has a thickness F of 50-500 p.m. In the case of a thickness F of less than 50 μm, since the elastic layer is too thin, this range is undesirable in view of degradation of transfer efficiency, durability, filming, image quality and so forth. In the case of a thickness F of more than 500 μm, since the elastic layer is too thick, this range is also undesirable in view of degradation of image quality such as filming or the like.

Surface layer 70c preferably has a hardness of 0.2-10 GPa in consideration of transfer efficiency, durability, filming, image quality and so forth.

Surface layer 70c preferably has an elastic modulus of 10-5000 in consideration of transfer efficiency, durability, filming, image quality, adhesion to the elastic layer, and so forth.

The ratio of an elastic modulus of surface layer 70c to another elastic modulus of elastic layer 70b is preferably 10-5000 in consideration of transfer efficiency, durability, filming, image quality, adhesion to the elastic layer, and so forth.

Surface layer 70c preferably has a thickness H of 100-1000 nm in consideration of transfer efficiency, durability, filming, image quality, adhesion to the elastic layer, and so forth.

The structure of surface layer 70c is not specifically limited. The structure composed of one layer may be allowed, and the structure composed of two layers may also be allowed. In the present figure, the structure composed of one layer is shown.

In cases where surface layer 70c is composed of two layers. The lower layer preferably has a hardness of 0.2-2.0 GPa in consideration of transfer efficiency, durability, filming, image quality, adhesion to the elastic layer, and so forth. The elastic modulus is preferably 1.0-10.0 GPa in consideration of durability, filming image quality and so forth. Further, the thickness is preferably 100-1000 nm in consideration of durability, filming, image quality and so forth.

The adjacent layer preferably has a hardness of 2.0-10.0 GPa in consideration of transfer efficiency, durability, filming, image quality and so forth. The elastic modulus is preferably 10.0-50.0 GPa in consideration of transfer efficiency, durability, filming, image quality and so forth. Further, the thickness is preferably 10-50 nm in consideration of transfer efficiency, durability, filming, image quality and so forth.

Hardness and elastic modulus of each of substrate 70a, elastic layer 70b and surface layer 70c are indicated by the values measured by a nanoindentation method.

The method of measuring hardness and elastic modulus via the nanoindentation method is a method by which the relationship between load and push-in depth (displacement amount) is measured while pushing a fine diamond indenter in a thin film to calculate plastic deformation hardness from the measured value.

### Measuring Conditions

Measuring instrument: NANO Indenter XP/DCM (manufactured by MTS Systems Corporation)

Measuring indenter: Diamond Berkovich indenter having an equilateral-triangular tip shape

Measuring environment: 20° C. and 60% RH

Measuring sample: An intermediate transfer member was cut into a size of 5 cm×5 cm to prepare a test sample.

Maximum load setting: 25 μN

Push-in speed: Load was applied in proportion to time at a speed to reach the maximum test load of 25 μN in 5 seconds.

The measuring method of layer thickness and elastic modulus of each of an upper layer and a lower layer in the case of a surface layer composed of two layers will be described.

The measuring method of layer thickness and elastic modulus of each of the upper layer and the lower layer with respect to layer thickness of the lower layer, the layer thickness of the surface layer (composed of an upper layer and a lower layer) is first measured; the upper layer is subsequently removed from the surface layer via polishing or the like to expose the lower layer; and the layer thickness of the lower layer is measured to determine it. The layer thickness of the upper layer is determined via calculation by subtracting the layer thickness of the lower layer from the layer thickness of the surface layer (composed of an upper layer and a lower layer).

### Measuring Method of Elastic Modulus of Each of Upper Layer and Lower Layer

Hardness and elastic modulus of the upper layer are directly measured by a nanoindentation method. With respect to hardness and elastic modulus of the lower layer, the upper layer is removed from the surface layer via polishing or the like to expose the lower layer, and they are measured by a nanoindentation method.

In addition, as to the measurement, ten points for each sample are measured at random, and a mean value thereof is designated as hardness measured by the nanoindentation method.

Further, thickness of the surface layer is measured using a measuring instrument “MXP 21” manufactured by MacScience Inc. The specific thickness measurement can be carried out by the following method. Copper is used as a target of an X-ray source, and operation is performed at 42 kV and 500 mA. A multilayer film parabolic mirror is employed for an incident monochrometer. A 0.05 mm×5 mm incident slit and a 0.03 mm×20 mm light receiving slit are employed. In accordance with a 2θ/θ scanning technique, measurement is conducted at a step width of 0.005° in the range from 0-5°, accompanied with 10 seconds for each step by an FT method. Curve fitting is applied to the resulting reflectivity curve employing a Reflectivity Analysis Program Ver. 1 produced by MacScience Inc., and each parameter is obtained in such a way that the residual sum of squares between the actually measured value and the fitting curve is minimized. The film thickness of a multilayer film can be obtained from each parameter.

When the surface layer is composed of one layer or at least two layers, the formation method is not specifically limited, and examples thereof include a PVD (physical vapor deposition method) such as a sputtering method, a vacuum evaporation method, an ion plating method, or the like, a CVD method (chemical vapor deposition method), an atmospheric plasma CVD method, and so forth. Of these, an atmospheric plasma CVD method is specifically preferable in consideration of adhesion to an elastic layer.

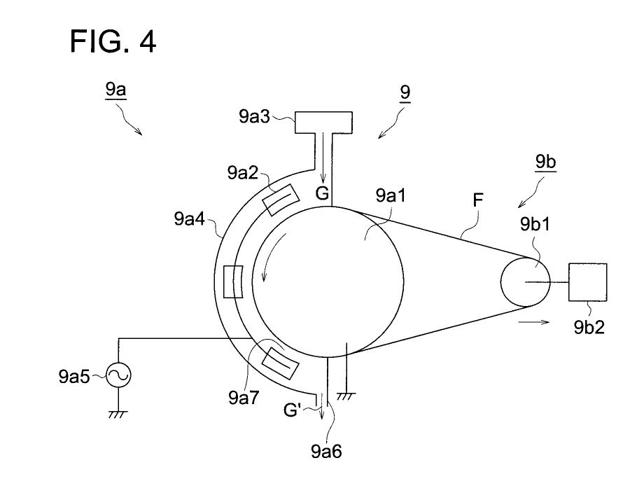

Next, an apparatus to form a surface layer relating to an endless belt-shaped intermediate transfer member in the present invention via an atmospheric plasma CVD method will be described in FIG. 4. Atmospheric pressure or a pressure close to the pressure described in the present invention means a pressure of from 20 kPa to 200 kPa, but in order to desirably obtain the effect of the present invention, it is a pressure of from 90 kPa to 110 kPa, and preferably pressure of from 93 kPa to 104 kPa.

FIG. 4 is a schematic diagram of a manufacturing apparatus equipped with an intermediate transfer belt as a belt-shaped intermediate transfer member, with which an inorganic compound layer is formed by an atmospheric plasma CVD method.

In the figure, numeral 9 represents a manufacturing apparatus. Manufacturing apparatus 9 possesses atmospheric plasma CVD apparatus 9a and material supplying apparatus 9b. Atmospheric plasma CVD apparatus 9a is equipped with roll electrode 9a1, at least one fixed electrode 9a2 placed along the outer circumference of roll electrode 9a1, mixed gas-supplying device 9a3, discharge vessel 9a4, high-frequency power supply 9a5 and exhaust tube 9a6. Symbol 9a7 represents a facing region between fixed electrode 9a and roll electrode 9a1, representing a discharge space in which discharge is conducted. In order to conduct discharge stably, a dielectric (unshown in the figure) should be provided on the discharge region surface of at least one of fixed electrode 9a2 and roll electrode 9a1, and dielectrics are preferably provided on the discharge region surfaces of both fixed electrode 9a2 and roll electrode 9a1. A ceramic such as aluminum oxide, titanium oxide or the like can be selected for a dielectric. In addition, the surface of fixed electrode 9a2 facing roll electrode 9a1 preferably has the same curvature as that of roll electrode 9a1 in order to make the distance to roll electrode 9a1 to be constant.

Mixed gas G obtained from at least raw material gas and discharge gas is prepared, and supplied to discharge vessel 9a4 from mixed gas supplying device 9a3. The inflow of air to discharge space 9a7 or the like is suppressed owing to discharge vessel 9a4.

High-frequency power supply 9a5 is connected to fixed electrode 9a2 to exhaust used exhaust gas G′ from exhaust tube 9a6.

A mixed gas in which a raw material gas to form a film as an inorganic compound layer, and inert gas such as a nitrogen gas, an argon gas or the like are mixed is supplied to discharge vessel 9a4 from mixed gas supplying device 9a3. In addition, it is further preferable to mix oxygen gas or hydrogen gas to accelerate reaction via redox reaction.

Mixed gas G is plasma-generated (excited) between fixed electrode 9a2 and roll electrode 9a1 by applying voltage to a high-frequency power supply, and a film {surface layer 70c (refer to FIG. 3)} owing to raw material gas contained in mixed gas G is deposited on an elastic layer in material F to manufacture intermediate transfer belt 70 as a belt-shaped intermediate transfer member shown in FIG. 3.

Usable high-frequency power supply 9a5 is not specifically limited, and for example, CF-5000-13M manufactured by Pearl Kogyo Co., Ltd. is usable.

As to the electric power supplied to high-frequency power supply 9a5, an electric power (output density) of at least 1 W/cm² is supplied to fixed electrode 9a2 so as to excite discharge gas, and plasma is generated to form a thin film. The upper limit of the power to be supplied to fixed electrode 9a2 is preferably 50 W/cm², and more preferably 20 W/cm². The lower limit is preferably 1.2 W/cm². Herein, the discharge area (cm²) means the area of the range where discharge is generated at the electrode.

Herein, the waveform of the high frequency electric field is not specifically limited. There are a continuous oscillation mode which is called a continuous mode with a continuous sine wave and a discontinuous oscillation mode which is called a pulse mode carrying out ON/OFF discontinuously, and either may be used, however, a method supplying the continuous sine wave at least to the second electrode side (the second high frequency electric field) is preferred in obtaining a uniform film with high quality.

Herein, a surface layer may be deposited via lamination employing mixed gas supplying device 9a3 and the plural fixed electrodes 9a2 situated on the downstream side with respect to the rotation direction of roll electrode 9a1, among plural fixed electrodes 9a2, so as to adjust the thickness of the surface layer.

Further, a supplying device (unshown in the figure), by which mixed gas from mixed gas supplying device 9a3 is directly supplied to discharge space 9a7, is provided; a surface layer is deposited by fixed electrode 9a2 and mixed gas supplying device 9a3 situated on the most downstream side with respect to the rotation direction of roll electrode 9a1; and another layer such as an adhesion layer to improve adhesiveness between a surface layer and an elastic layer, for example, may also be formed with fixed electrode 9a2 and mixed gas supplying device 9a3 situated on the further upstream side.

Further, in order to improve adhesiveness between surface layer 70c (refer to FIG. 3) and elastic layer 70b, a fixed electrode and a gas supplying device to supply gas such as argon, oxygen or the like may be provided on the upstream side of fixed electrode 9a2 and mixed gas supplying device 9a3 to form surface layer 70c (refer to FIG. 2), and subjected to a plasma treatment to activate the surface of elastic layer 70b (refer to FIG. 3).

Material supplying device 9b possesses driven roller 9b1 and tension-providing device 9b2 to pull driven roller 9b1 in the arrow direction in the figure. Endless belt-shaped material F is supported by roll electrode 9a1 and driven roller 9b1, applying the predetermined tension by tension-providing device 9b2, and is rotatably tension-supported via driven roller 9b1 along with rotation of roll electrode 9a1 (in the arrow direction in the figure). Tension-providing device 9b2 releases providing of tension, for example, during replacement of material F, allowing easy replacement of material F. Material F shown in the figure means material in the situation where up to an elastic layer in intermediate transfer belt 70 shown in FIG. 3 is formed (substrate 70a/elastic layer 70b).

Discharge gas used for a manufacturing apparatus, by which formation thereof is carried out employing an atmospheric plasma CVD method shown in FIG. 4, means gas to be plasma-excited, and examples thereof include nitrogen, argon, helium, neon, krypton, xenon, others, and a mixture thereof. Of these, nitrogen, helium and argon are preferably used, and nitrogen is specifically preferable in view of low cost.

Further, usable examples of raw material to form a surface layer include a gas or liquid organometallic compound at room temperature, specifically an alkyl metal compound or a metal alkoxide compound, and an organic metal complex compound. The phase state of these raw materials are not necessarily a gas phase at ordinary temperature and pressure, a liquid phase as well as a solid phase is usable as long as it is one in which gasification is possible to be produced via melting, vaporization, sublimation or the like through application of heat, depressurization or the like employing a mixed gas supplying device.

The raw material gas produces a state of plasma in the discharge space, and contains components to form a thin film. Examples thereof include an organometallic compound, an organic compound, an inorganic compound and so forth.

Examples of silicon compounds include silane, tetramethoxysilane, tetraethoxysilane (TEOS), tetra-n-propoxysilane, tetra-iso-propoxysilane, tetra-n-butoxysilane, tetra-t-butoxysilane, dimethyldimethoxysilane, dimethyldiethoxysilane, diethyldimethoxysilane, diphenyldimethoxysilane, methyltriethoxysilane, ethyltrimethoxysilane, phenyltriethoxysilane, (3,3,3-trifluoropropyl) trimethoxysilane, hexamethyldisiloxane, his (dimethylamino) dimethylsilane, bis(dimethylamino) methylvinylsilane, bis(ethylamino) dimethylsilane, N,O-bis(trimethylsilyl)acetamide, bis (trimethylsilyl) carbodiimide, diethylaminotrimethylsilane, dimethylaminodimethylsilane, hexamethyldisilazane, heaxamethylcyclotrisilazane, heptamethylsilazane, nonamethyltrisilazane, octamethylcyclotetrasilazane, tetrakisdimethylaminosilane, tetraisocyanatesilane, tetramethyldisilazane, tris (dimethylamino) silane, triethoxyfluorosilane, allyldimethylsilane, allyltrimethylsilane, benzyltrimethylsilane, bis(trimethylsilyl)acetylene, 1,4-bistrimethylsilyl-1,3-butadiine, di-t-butylsilane, 1,3-disilabutane, bis(trimethylsilyl)methane, cyclopentadiphenyltrimethylsilane, phenyldimethylsilane, phenyltrimethylsilane, propagyltrimethylsilane, tetramethylsilane, trimethylsilylacetylene, 1-(trimethylsilyl)-1-propine, tris (trimethylsilyl)methane, tris (trimethylsilyl) silane, vinyltrimethylsilane, hexamethyldisilane, octamethylcyclotetrasiloxane, tetramethylcyclotetrasiloxane, hexamethylcyclotetrasiloxane and M-silicate 51, but the present invention is not limited thereto.

Examples of titanium compounds include organometallic compounds such as tetradimethylamino titanium and so forth; metal hydrogen compounds such as monotitanium, dititanium and so forth; metal halogenated compounds such as titanium dichloride, titanium trichloride, titanium tetrachloride and so forth; and metal alkoxides such as tetraethoxy titanium, tetraisopropoxy titanium, tetrabutoxy titanium and so forth, but the present invention is not limited thereto.

Examples of aluminum compounds include aluminum n-butoxide, aluminum s-butoxide, aluminum t-butoxide, aluminum diisopropoxide ethylacetoacetate, aluminum ethoxide, aluminum hexafluoropentanedionato, aluminum isopropoxide, aluminum 4-pentanedionato, dimethyl aluminum chloride and so forth, but the present invention is not limited thereto.

Further, the above-described raw material may be used singly, or may be used by mixing at least two kinds of components.

Next, material constituting intermediate transfer belt 70, endless belt-shaped substrate 70a and a method of manufacturing elastic layer 70b as shown in FIG. 3 will be described.

### (Substrate of Intermediate Transfer Belt)

Endless belt-shaped substrate 70a (refer to FIG. 3) exhibits conductivity obtained by dispersing a conductive agent in a resin.

### (Substrate)

Substrate 70a (refer to FIG. 3) is one exhibiting stiffness to reduce influence to a transfer portion by avoiding deformation of an intermediate transfer member, caused by a load applied to the intermediate transfer belt from a cleaning blade as a cleaning member.

The material to be used is not specifically limited, as long as it exhibits hardness desired to be used in the present invention. Usable examples of the resin materials include engineering plastics such as polycarbonate, polyphenylene sulfide, polyfluorovinylidene, polyimide, polyether, ether ketone, an ethylene tetrafluoroethylene copolymer, polyamide, polyphenylene sulfide, and so forth. Of these, polyimide, polycarbonate and polyphenylene sulfide are preferable. Further, material in which the foregoing resin material and the following elastic material are blended is also usable. Examples of the elastic material include polyurethane, chlorinated polyisoprene, NBR, chloropyrene rubber, EPDM, hydrogen addition polybutadiene, butyl rubber, silicone rubber, and so forth. These may be used singly, or may be used in combination with at least two kinds. Of these, it is preferred to contain polyphenylene sulfide or a polyimide resin. The polyimide resin is formed via heating of a polyamic acid as a precursor of a polyimide resin. Further, the polyamic acid can be obtained via reaction in a solution state by dissolving tetracarboxylic dianhydride or its derivative, and an approximately equimolar mixture of diamine in an organic polar solvent.

In addition, in the present invention, when using a polyimide based resin for substrate 70a (refer to FIG. 3), the polyimide based resin preferably has a content of at least 51%, based on the substrate.

It is preferred that a conductive material is added into a resin material constituting substrate 70a (refer to FIG. 3), and an electrical resistivity value (volume resistance) is adjusted from 10⁵ Ω·cm to 10¹¹ Ω·cm.

Carbon black is usable as a conductive material added into a resin material. As the carbon black, neutral or acidic carbon black is usable. Though a consumption amount of conductive material depends on kinds of the conductive material to be used, the conductive material may be added in such a way that volume resistance and surface resistance of an intermediate transfer member fall within the predetermined range, and has a content of 10-20 parts by weight and preferably has a content of 10-16 parts by weight, based on 100 parts by weight of a resin material.

The substrate to be used in the present invention is possible to be prepared by a commonly known conventional method. For example, after melting a resin as a material with an extruder, and molding it in the form of a cylinder by an inflation method employing a ring-shaped die, a ring-shaped endless belt-shaped substrate can be prepared by slicing the resulting into rings. In addition, a resin material to be usable for a substrate in an intermediate belt is also usable for preparation of a drum-shaped substrate.

### (Elastic Layer)

Elastic layer 70b (refer to FIG. 3) is not specifically limited, and any rubber material or thermoplastic elastomer is arbitrarily usable. Those can be selected from styrene-butadiene rubber (SBR), high-styrene rubber, polybutadiene rubber (BR), polyisoprene rubber (UR), an ethylene-propylene copolymer, nitrile-butadiene rubber, chloroprene rubber (CR), ethylene-propylene-diene rubber (EPDM), butyl rubber, silicone rubber, fluorine rubber, nitrile rubber, urethane rubber, acrylic rubber (ACM, ANM), epichlorohydrin rubber, norbornene rubber and so forth. Chloroprene rubber, nitrile rubber, stylene-butadiene rubber, silicone rubber, urethane rubber and an ethylene-propylene copolymer are specifically preferable. These may be used singly, or may be used in combination with at least two kinds.

On the other hand, usable examples of the thermoplastic elastomer include a polyester based elastomer, a polyurethane based elastomer, a styrene-butadienetriblock based elastomer, a polyolefin based elastomer and so forth.

Further, the elastic layer may be a layer formed by using a material in which a resin material and an elastic material to be used for a substrate are blended.

For example, as a silicone rubber material, a polyorganosiloxane composition containing a vinyl group is used. As the silicone rubber, used is a thermal vulcanization type silicone rubber capable of vulcanization (curing) with a vulcanizing agent made from peroxide and two liquid type silicone rubber capable of curing with an addition reaction solvent. Further, each of various compounding agents such as a filler, an increasing amount filler, a vulcanizing agent, a colorant, a conductive material, a heat-resisting agent, a pigment and so forth can be added into an elastic layer, depending on intended use and design purpose of a seamless belt. Further, a plasticity degree of a synthetic resin is changed depending on an addition amount of the compounding agent and so forth, but as a plasticity degree of a rigid resin before curing, one having a plasticity degree of 120 or less is preferably used.

As to an elastic layer, an electrical resistivity value (volume resistance) can be adjusted from 10⁵ Ω·cm to 10¹¹ Ω·cm by dispersing a conductive material in an elastic material.

Usable examples of a conductive material added into the elastic layer include carbon black, zinc oxide, tin oxide, silicon carbide and so forth. Though a consumption amount of the conductive material depends on kinds of the conductive material to be used, the conductive material may be added in such a way that volume resistance and surface resistance of the elastic layer fall within the predetermined range, and has a content of 10-20 parts by weight and preferably has a content of 10-16 parts by weight, based on 100 parts by weight of the elastic layer.

### Method of Forming Elastic Layer

In order to prepare elastic layer 70b (refer to FIG. 3), a coating film can be formed by a commonly known coating method such as a dip coating method disclosed in Japanese Patent O.P.I. Publication No. 2006-255615, a circular slide hopper type coating method disclosed in Japanese Patent O.P.I. Publication No. 10-104855, a circularly coating method disclosed in Japanese Patent O.P.I. Publication No. 2007-136423, or a method obtained by using a dip coating method and a circular slide hopper type coating method in combination, but the present invention is not limited thereto.

Specifically, as a method of forming an elastic layer on an endless belt-shaped resin substrate, a circular endless belt-shaped resin substrate is arranged to be set to a cylindrical core material, and the resulting set is inserted in a vessel in which a coating solution for the elastic layer is stored, and is immersed. In this case, after conducting a couple of repeated immersions to form a coating film having the predetermined thickness, the resulting set is pulled out of the coating solution. Next, after drying and removal of the solvent, a heat treatment (from at 60° C. for 60 minutes to at 150° C. for 60 minutes) is conducted to prepare an elastic layer.

As to also a method of forming an elastic layer on a cylindrical metal subs ate similarly to the case of an endless belt-shaped resin substrate, rubber, elastomer, resin or the like is molded on the metal roll via melt molding, injection molding, dip coating, spray coating or the like to prepare it.

### (Surface Layer)

Surface layer 70c (refer to FIG. 3) is preferably formed of at least one inorganic compound selected from the group consisting of metal oxide, metal nitride, and metal oxide-nitride. Further, an inorganic compound is preferably formed from metal oxide, metal nitride or metal oxide-nitride of at least one selected from the group consisting of In, Sn, Cd, Zn, Al, Sb, Ge, W, Mo, Si, Zr, Ce, Mg and Ti. Specifically, Al, Si and Ti are preferable. Specifically, cited are silicon oxide, silicon nitride, silicon oxide-nitride, titanium oxide, titanium oxide-nitride, titanium nitride, aluminum oxide, and so forth. Further, silicon oxide or silicon oxide containing carbon is most preferable.

### Example

Next, the present invention will be described in detail referring to examples, but the present invention is not limited thereto. Incidentally, “parts” and “%” described in the examples represent “parts by weight” and “% by weight”, respectively, unless otherwise specifically mentioned.

An endless-belt shaped substrate having a thickness of 100 μm, which is made of polyimide (PI) containing a conductive material was prepared. Carbon black is usable as a conductive material added into a resin material. As the carbon black, neutral or acidic carbon black is usable. Though a consumption amount of conductive material depends on kinds of the conductive material to be used, the conductive material may be added in such a way that resistance and surface resistance of an intermediate transfer member falls within the predetermined range, and has a content of 10-20 parts by weight and preferably has a content of 10-16 parts by weight, based on 100 parts by weight of a resin material. An elastic modulus thereof was 5 GPa.

### (Preparation of Elastic Layer)

Each of elastic layers having a varied elastic modulus and thickness as shown in Table 1 was formed on the outer circumference of a prepared endless belt-shaped substrate by a dip coating method, and endless belt-shaped substrates and formed thereon, up to the elastic layer were prepared to designate them as 1-1 to 1-28. In addition, in order to vary the elastic modulus, kinds, the addition amount and the compounding ratio of various compounding agents such as a filler, an increasing amount filler, a vulcanizing agent, a colorant, a conductive material, a heat resistant agent, a pigment and so forth to be added into an elastic layer may be adjusted so as to obtain the predetermined hardness. These materials are not specifically limited, and can be selected as needed, whereby the compounding agent may not be used. When conducting dip coating, change of the thickness was made by varying the pull-up speed.

The elastic modulus indicates a value obtained via measurements by a nanoindentation method described in the present specification. The thickness indicates a value obtained via measurements by a method described in the present specification employing “MXP21” manufactured by MAC Science Ltd.

TABLE 1

| | Substrate | | Elastic layer | | |
|---|---|---|---|---|---|
| | | Elastic | Elastic | Thickness | |
| | | modulus | modulus | | |
| *1 | Material | (GPa) | (MPa) | (μm) | Material |
| 1-1 | PI | 5 | 5 | 150 | Nitrile rubber |
| 1-2 | PI | 5 | 10 | 150 | Nitrile rubber |
| 1-3 | PI | 5 | 50 | 150 | Nitrile rubber |
| 1-4 | PI | 5 | 100 | 150 | Nitrile rubber |
| 1-5 | PI | 5 | 200 | 150 | Nitrile rubber |
| 1-6 | PI | 5 | 300 | 150 | Nitrile rubber |
| 1-7 | PI | 5 | 10 | 40 | Nitrile rubber |
| 1-8 | PI | 5 | 10 | 50 | Nitrile rubber |
| 1-9 | PI | 5 | 10 | 100 | Nitrile rubber |
| 1-10 | PI | 5 | 10 | 300 | Nitrile rubber |
| 1-11 | PI | 5 | 10 | 500 | Nitrile rubber |
| 1-12 | PI | 5 | 10 | 600 | Nitrile rubber |
| 1-13 | PI | 5 | 200 | 40 | Nitrile rubber |
| 1-14 | PI | 5 | 200 | 50 | Nitrile rubber |
| 1-15 | PI | 5 | 200 | 100 | Nitrile rubber |
| 1-16 | PI | 5 | 200 | 300 | Nitrile rubber |
| 1-17 | PI | 5 | 200 | 500 | Nitrile rubber |
| 1-18 | PI | 5 | 200 | 600 | Nitrile rubber |
| 1-19 | PI | 5 | 5 | 50 | Nitrile rubber |
| 1-20 | PI | 5 | 10 | 50 | Nitrile rubber |
| 1-21 | PI | 5 | 50 | 50 | Nitrile rubber |
| 1-22 | PI | 5 | 200 | 50 | Nitrile rubber |
| 1-23 | PI | 5 | 300 | 50 | Nitrile rubber |
| 1-24 | PI | 5 | 5 | 500 | Nitrile rubber |
| 1-25 | PI | 5 | 10 | 500 | Nitrile rubber |
| 1-26 | PI | 5 | 50 | 500 | Nitrile rubber |
| 1-27 | PI | 5 | 200 | 500 | Nitrile rubber |
| 1-28 | PI | 5 | 300 | 500 | Nitrile rubber |

*1: Endless belt-shaped substrate No. (the substrate and formed thereon, up to the elastic layer)

### (Preparation of Intermediate Transfer Member)

### {Formation of Inorganic Compound Layer (Surface Layer)}

An inorganic compound (silicon oxide) layer having a thickness of 150 nm was formed on an elastic layer provided on each of the resulting endless belt substrates Nos. 1-1 to 1-28 on which up an elastic layer was formed, under the following conditions employing an atmospheric plasma CVD manufacturing apparatus as shown in FIG. 4 to prepare intermediate transfer belt 1, and the resulting were designated as sample Nos. 101 to 128. In addition, thickness of the inorganic compound (silicon oxide) layer is a value obtained via measurements employing “MXP21” manufactured by MAC Science Ltd. by a method described in the present specification.

The inorganic compound (silicon oxide) layer had an elastic modulus of 5 GPa, a hardness of 1 GPa and a thickness of 500 nm. The elastic modulus indicates a value measured by a nanoindentation method described in the present specification.

The following mixed gas composition was used for material to form an inorganic compound layer, and an inorganic compound (silicon oxide) layer was formed under the following film formation condition. As a dielectric to coat each of electrodes in an atmospheric plasma treatment apparatus in this case, one on which aluminum having one surface thickness of 1 mm was coated by ceramic spraying was used for both of the facing electrodes. A spacing distance between the electrodes after coating was set to 1 mm. Further, the metal mother material on which a dielectric was coated was in accordance with stainless steel jacket specification including a coating function with cooling water, and cooling was conducted during discharge while controlling electrode temperature with the cooling water to form an inorganic compound (SiₓO_{y} as silicon oxide). As a dielectric to coat each of electrodes in a discharge treatment apparatus, one on which aluminum was coated by ceramic spraying was used for both of the facing electrodes. Further, the metal mother material on which a dielectric was coated was in accordance with stainless steel jacket specification including a coating function with cooling water, and cooling was conducted during discharge while controlling electrode temperature with the cooling water.

### <Mixed Gas Composition>

| | | |
|---|---|---|
| Discharge gas: Nitrogen gas | 94.93% | by volume |
| Film-forming (raw material) gas: | 0.07% | by volume |
| Tetraethoxysilane | | |
| Reaction gas: Oxygen gas | 5.00% | by volume |

Each raw material is heated to produce steam, and mixed and diluted with discharge gas and reaction gas having subjected to extra heating in advance so as not to coagulate the raw material, and the raw material was subsequently supplied into the discharge space.

### <Formation Condition>

Power supply on the first electrode side:

High-frequency power supply manufactured by
OYO ELECTRIC Co., Ltd.

| | |
|---|---|
| Frequency | 80 kHz |
| Power density | 10 W/cm² |

Power supply on the second electrode side:

High-frequency power supply manufactured by
Pearl Kogyo Co., Ltd.

| | | |
|---|---|---|
| Frequency | 13.56 | MHz |
| Power density | 10 | W/cm² |

In order to vary hardness and elastic modulus, kinds, amount, composition ratio, frequency and power density of a power supply may be adjusted so as to obtain the predetermined amount. These techniques are not specifically limited, and can be selected as needed. Thickness was changed by varying a film formation rate.

### Evaluation

With respect to the resulting samples No. 101 to No. 128, transfer efficiency, durability and filming are measured by the following method, and results evaluated in accordance with the following evaluation ranks are shown in FIG. 2.

### Measurement of Transfer Efficiency

Employing a printer (magicolor 544ODL, manufactured by Konica Minolta Business Technologies, Inc.), an intermediate transfer belt was removed from the inside, and each of the resulting samples No. 101 No. 128 was installed. A polymerization toner having an average particle diameter of 6.5 μm was placed in this printer, and each color of yellow, magenta, cyan and black was printed in maximal toner density onto Konica Minolta CF paper sheet (produced by Konica Minolta Business Technologies, Inc.). The toner coating amount transferred onto the print paper sheet and the residual toner amount on the belt were measured to obtain optical (reflection) density, and the measured results were converted into the toner amount in accordance with the relationship between the toner amount and the optical density obtained in advance to determine toner transfer ratio (%) from the following formula

Transfer ratio(%)={Toner amount transferred onto a test print paper sheet/(Toner amount transferred onto a test print paper sheet+Residual toner amount on a belt)}×100

### Evaluation Ranks

A: A transfer ratio of 98% or more
B: A transfer ratio of 95% or more and less than 98%
C: A transfer ratio of 90% or more and less than 95%
D: A transfer ratio of less than 90%

### Measurement of Durability

Employing the printer having been used in the transfer efficiency measurement, 300000 copies were printed on Konica Minolta CF paper (A4) sheets in accordance with a test pattern of 5% image ratio for each toner color at a temperature of 23° C. and a humidity of 50% RH, and subsequently, presence or absence of image quality was visually observed with respect to the first print and the 300000^{th} print.

### Evaluation Ranks

A: There is no image failure observed in the first print as well as the 300000′ print, and further, no problematic image failure is observed.
B: There is no image failure observed in the first print, but image failure slightly observed in the 300000^{th} print, resulting in practically acceptable quality.
C: There is no image failure observed in the first print, but image failure observed in the 300000^{th} print, resulting in practically acceptable quality.
D: There is no image failure observed in the first print, but clear image failure observed in the 300000^{th} print, resulting in practically problematic quality.
E: There is no image failure observed in the first print, but image failure largely observed in the 300000^{th} print, resulting in practically unacceptable quality.

### Measurement of Filming

When measuring durability, after completing the 300000^{th} print, an intermediate transfer belt was removed from the apparatus, and filming of the surface was visually observed.

### Evaluation Ranks of Filming

A: No filming is observed on an intermediate transfer belt at all. B: Filming is slightly observed on an intermediate transfer belt, but no practically problematic level results.
C: Filming is slightly observed around an intermediate transfer belt, and a practically problematic level results.

TABLE 2

| | Endless | | | | |
|---|---|---|---|---|---|
| | belt-shaped | | | | |
| | substrate | | | | |
| | No. (the | | | | |
| | substrate | | | | |
| | and formed | | | | |
| | thereon, | | | | |
| Sample | up to the | Transfer | | | |
| No. | elastic layer) | efficiency | Durability | Filming | Remarks |
| 101 | 1-1 | A | D | C | Comparative |
| | | | | | example |
| 102 | 1-2 | A | A | A | Present |
| | | | | | invention |
| 103 | 1-3 | A | A | A | Present |
| | | | | | invention |
| 104 | 1-4 | A | A | A | Present |
| | | | | | invention |
| 105 | 1-5 | A | A | A | Present |
| | | | | | invention |
| 106 | 1-6 | C | B | C | Comparative |
| | | | | | example |
| 107 | 1-7 | D | D | C | Comparative |
| | | | | | example |
| 108 | 1-8 | B | B | A | Present |
| | | | | | invention |
| 109 | 1-9 | A | A | A | Present |
| | | | | | invention |
| 110 | 1-10 | A | A | A | Present |
| | | | | | invention |
| 111 | 1-11 | A | B | A | Present |
| | | | | | invention |
| 112 | 1-12 | A | D | C | Comparative |
| | | | | | example |
| 113 | 1-13 | D | D | C | Comparative |
| | | | | | example |
| 114 | 1-14 | B | B | A | Present |
| | | | | | invention |
| 115 | 1-15 | A | A | A | Present |
| | | | | | invention |
| 116 | 1-16 | A | A | A | Present |
| | | | | | invention |
| 117 | 1-17 | A | B | A | Present |
| | | | | | invention |
| 118 | 1-18 | A | D | C | Comparative |
| | | | | | example |
| 119 | 1-19 | B | D | C | Comparative |
| | | | | | example |
| 120 | 1-20 | B | B | A | Present |
| | | | | | invention |
| 121 | 1-21 | B | B | A | Present |
| | | | | | invention |
| 122 | 1-22 | B | B | A | Present |
| | | | | | invention |
| 123 | 1-23 | C | B | C | Comparative |
| | | | | | example |
| 124 | 1-24 | A | D | C | Comparative |
| | | | | | example |
| 125 | 1-25 | A | B | A | Present |
| | | | | | invention |
| 126 | 1-26 | A | B | A | Present |
| | | | | | invention |
| 127 | 1-27 | B | B | A | Present |
| | | | | | invention |
| 128 | 1-28 | C | B | C | Comparative |
| | | | | | example |

Sample Nos. 102-105, 108-111, 114-117, 120-122, and 125-127 each having a thickness of 50-500 μm, in which an elastic layer has an elastic modulus of 10-100 MPa, exhibited excellent performance in any of transfer efficiency, durability and filming. Sample Nos. 101, 119 and 124 falling outside the range of the present invention, in which the elastic layer had an elastic modulus of 5 MPa, exhibited inferior performance in durability and filming. Sample Nos. 106, 123 and 128 falling outside the range of the present invention, in which the elastic layer had an elastic modulus of 300 MPa, exhibited inferior performance in transfer efficiency and filming. Sample Nos. 107 and 113 falling outside the range of the present invention, in which the elastic layer had a thickness of 40 μm, exhibited inferior performance in durability and filming. Sample Nos. 112 and 118 falling outside the range of the present invention, in which the elastic layer had a thickness of 600 μm, exhibited inferior performance in durability and filming. Effectiveness produced by the present invention has been confirmed.

### Example 2

### (Preparation of Endless Belt-Shaped Substrate)

The same endless belt-shaped substrate as in Example 1 was prepared.

### (Preparation of Intermediate Transfer Member)

Employing the resulting endless belt-shaped substrate, intermediate transfer members each having a structure of substrate/elastic layer/surface layer were prepared by varying the ratio of hardness of the surface layer to hardness of the elastic layer, hardness of the surface layer, elastic modulus of the surface layer, and thickness of the surface layer to designate Sample Nos. 201 to 225.

Hardness and elastic modulus of the surface layer are measured by the same method as in Example 1. Thickness of the surface layer is measured by the same method as in Example 1. Thickness and hardness of the elastic layer are measured by the same method as in Example 1.

### (Preparation of Elastic Layer)

Each of elastic layers having various values of elastic modulus and thickness as shown in Table 3 were formed on the outer-circumference of the resulting endless belt-shaped substrate by a dip coating method, and an endless belt-shaped substrate and formed thereon, up to an elastic layer were prepared. In addition, in order to vary the elastic modulus, kinds, the addition amount and the compounding ratio of various compounding agents such as a filler, an increasing amount filler, a vulcanizing agent, a colorant, a conductive material, a heat resistant agent, a pigment and so forth to be added into an elastic layer may be adjusted so as to obtain the predetermined hardness. These materials are not specifically limited, and can be selected as needed, whereby the compounding agent may not be used. When conducting dip coating, change of the thickness was made by varying the pull-up speed.

The elastic modulus indicates a value obtained via measurements by a nanoindentation method described in the present specification. The thickness indicates a value obtained via measurements by a method described in the present specification employing “MXP21” manufactured by MAC Science Ltd. Nitrile rubber was employed as a material.

### <Formation of Inorganic Compound Layer (Surface Layer)>

Employing an atmospheric plasma CVD manufacturing apparatus shown in FIG. 4, an inorganic compound (silicon oxide) layer having a thickness of 150 nm was formed on an elastic layer of each of endless belt-shaped substrates on which up to the resulting elastic layer was formed under the following condition to prepare intermediate transfer belt 1, and they were designated as Sample Nos. 201 to 225. Thickness of the inorganic compound (silicon oxide) layer indicates a value obtained via measurements by a method described in the present specification employing “MXP21” manufactured by MAC Science Ltd.

The inorganic compound (silicon oxide) layer had an elastic modulus of 5 GPa. The elastic modulus indicates a value obtained via measurements by a nanoindentation method described in the present specification.

The following mixed gas composition was used for material to form an inorganic compound layer, and an inorganic compound (silicon oxide) layer was formed under the following film formation condition. As a dielectric to coat each of electrodes in an atmospheric plasma treatment apparatus in this case, one on which aluminum having one surface thickness of 1 mm was coated by ceramic spraying was used for both of the facing electrodes. A spacing distance between the electrodes after coating was set to 1 mm. Further, the metal mother material on which a dielectric was coated was in accordance with stainless steel jacket specification including a coating function with cooling water, and cooling was conducted during discharge while controlling electrode temperature with the cooling water to form an inorganic compound (SiₓO_{y} as silicon oxide). As a dielectric to coat each of electrodes in a discharge treatment apparatus, one on which aluminum was coated by ceramic spraying was used for both of the facing electrodes. Further, the metal mother material on which a dielectric was coated was in accordance with stainless steel jacket specification including a coating function with cooling water, and cooling was conducted during discharge while controlling electrode temperature with the cooling water.

### <Mixed Gas Composition>

| | | |
|---|---|---|
| Discharge gas: Nitrogen gas | 94.93% | by volume |
| Film-forming (raw material) gas: | 0.07% | by volume |
| Tetraethoxysilane | | |
| Reaction gas: Oxygen gas | 5.00% | by volume |

Each raw material is heated to produce steam, and mixed and diluted with discharge gas and reaction gas having subjected to extra heating in advance so as not to coagulate the raw material, and the raw material was subsequently supplied into the discharge space.

### <Formation Condition>

Power supply on the first electrode side:

High-frequency power supply manufactured by
OYO ELECTRIC Co., Ltd.

| | |
|---|---|
| Frequency | 80 kHz |
| Power density | 10 W/cm² |

Power supply on the second electrode side:

High-frequency power supply manufactured
by Pearl Kogyo Co., Ltd.

| | | |
|---|---|---|
| Frequency | 13.56 | MHz |
| Power density | 10 | W/cm² |

In order to vary hardness and elastic modulus, kinds, amount, composition ratio, frequency and power density of a power supply may be adjusted so as to obtain the predetermined amount. These techniques are not specifically limited, and can be selected as needed. Thickness was changed by varying a film formation rate.

TABLE 3

| | | | | | | | Ratio of elastic |
|---|---|---|---|---|---|---|---|
| | | | | | | | modulus |
| | Elastic layer | | | Surface layer | | | of surface layer |
| | | Elastic | | | | Elastic | to elastic |
| Sample | Thickness | modulus | | Thickness | Hardness | modulus | modulus |
| No. | (μm) | (MPa) | Material | (nm) | (GPa) | (GPa) | of elastic layer |
| 201 | 150 | 50 | Nitrile rubber | 500 | 0.1 | 0.5 | 10 |
| 202 | 150 | 50 | Nitrile rubber | 500 | 0.2 | 1.0 | 20 |
| 203 | 150 | 50 | Nitrile rubber | 500 | 0.5 | 2.5 | 50 |
| 204 | 150 | 50 | Nitrile rubber | 500 | 1.0 | 5.0 | 100 |
| 205 | 150 | 50 | Nitrile rubber | 500 | 10.0 | 50.0 | 1000 |
| 206 | 150 | 50 | Nitrile rubber | 500 | 12.0 | 60.0 | 120 |
| 207 | 150 | 50 | Nitrile rubber | 90 | 1.0 | 5.0 | 100 |
| 208 | 150 | 50 | Nitrile rubber | 100 | 1.0 | 5.0 | 100 |
| 209 | 150 | 50 | Nitrile rubber | 300 | 1.0 | 5.0 | 100 |
| 210 | 150 | 50 | Nitrile rubber | 500 | 1.0 | 5.0 | 100 |
| 211 | 150 | 50 | Nitrile rubber | 800 | 1.0 | 5.0 | 100 |
| 212 | 150 | 50 | Nitrile rubber | 1000 | 1.0 | 5.0 | 100 |
| 213 | 150 | 50 | Nitrile rubber | 1200 | 1.0 | 5.0 | 100 |
| 214 | 150 | 10 | Nitrile rubber | 500 | 0.2 | 1.0 | 100 |
| 215 | 150 | 50 | Nitrile rubber | 500 | 0.2 | 1.0 | 20 |
| 216 | 150 | 100 | Nitrile rubber | 500 | 0.2 | 1.0 | 10 |
| 217 | 150 | 200 | Nitrile rubber | 500 | 0.2 | 1.0 | 5 |
| 218 | 150 | 10 | Nitrile rubber | 500 | 1.0 | 5.0 | 500 |
| 219 | 150 | 50 | Nitrile rubber | 500 | 1.0 | 5.0 | 100 |
| 220 | 150 | 100 | Nitrile rubber | 500 | 1.0 | 5.0 | 50 |
| 221 | 150 | 200 | Nitrile rubber | 500 | 1.0 | 5.0 | 25 |
| 222 | 150 | 10 | Nitrile rubber | 500 | 10.0 | 50.0 | 5000 |
| 223 | 150 | 50 | Nitrile rubber | 500 | 10.0 | 50.0 | 1000 |
| 224 | 150 | 100 | Nitrile rubber | 500 | 10.0 | 50.0 | 500 |
| 225 | 150 | 200 | Nitrile rubber | 500 | 10.0 | 50.0 | 250 |

### Evaluation

The resulting samples (No. 201-No. 225) are measured to obtain measured values of transfer efficiency, durability and filming. Results evaluated in accordance with the same evaluation ranks as in Example 1 are shown in Table. 4.

TABLE 4

| Sample No. | Transfer efficiency | Durability | Filming | Remarks |
|---|---|---|---|---|
| 201 | A | C | B | Present invention |
| 202 | A | B | A | Present invention |
| 203 | A | A | A | Present invention |
| 204 | A | A | A | Present invention |
| 205 | A | B | A | Present invention |
| 206 | A | C | B | Present invention |
| 207 | A | C | B | Present invention |
| 208 | A | B | A | Present invention |
| 209 | A | A | A | Present invention |
| 210 | A | A | A | Present invention |
| 211 | A | A | A | Present invention |
| 212 | A | B | A | Present invention |
| 213 | A | C | B | Present invention |
| 214 | A | A | A | Present invention |
| 215 | A | A | A | Present invention |
| 216 | A | A | A | Present invention |
| 217 | B | B | B | Present invention |
| 218 | A | A | A | Present invention |
| 219 | A | A | A | Present invention |
| 220 | A | A | A | Present invention |
| 221 | A | A | A | Present invention |
| 222 | A | C | B | Present invention |
| 223 | A | A | A | Present invention |
| 124 | A | A | A | Present invention |
| 225 | A | A | A | Present invention |

When preparing an intermediate transfer member having a structure of substrate/elastic layer/surface layer, excellent performance in transfer efficiency, durability and filming was obtained via preparation within the range where the surface layer had a hardness of 0.2-10 GPa, an elastic modulus of 1.0-50 GPa, a thickness of 100-1000 nm, and a ratio of hardness of the surface layer to hardness of the elastic layer of 10-500.

### Example 3

### (Preparation of Endless Belt-Shaped Substrate)

The same endless belt-shaped substrate as in Example 1 was prepared.

### (Preparation of Elastic Layer)

The same elastic layer as that of endless belt-shaped substrate No. 1-3 and provided thereon, up to the elastic layer prepared in Example 1 is formed on the prepared endless belt-shaped substrate for an endless belt-shaped substrate. In addition, nitrile rubber is used as a material, and the elastic layer had a layer thickness of 150 μm and an elastic modulus of 50 MPa.

### (Preparation of Intermediate Transfer Member)

When forming a surface layer on each of endless belt-shaped substrates and formed thereon, up to an elastic layer, as shown in FIG. 5, the surface layer is composed of a lower layer and an upper layer, intermediate transfer members are prepared by varying hardness and elastic modulus of the lower layer and hardness, elastic modulus and thickness of the upper layer to designate them as Sample Nos. 301 to 324.

### Preparation of Sample No. 301

### (Formation of Lower Layer)

The following lower layer mixed gas composition was used for material to form a lower layer, and the lower layer was formed under the following film formation condition. As a dielectric to coat each of electrodes in an atmospheric plasma treatment apparatus in this case, one on which aluminum having one surface thickness of 1 mm was coated by ceramic spraying was used for both of the facing electrodes. A spacing distance between the electrodes after coating was set to 1 mm. Further, the metal mother material on which a dielectric was coated was in accordance with stainless steel jacket specification including a coating function with cooling water, and cooling was conducted during discharge while controlling electrode temperature with the cooling water to form a lower layer (made of SiₓO_{y}).

### <Lower Layer Mixed Gas Composition>

| | | |
|---|---|---|
| Discharge gas: Nitrogen gas | 94.93% | by volume |
| Film-forming (raw material) gas: Tetraethoxysilane | 0.07% | by volume |
| Reaction gas: Oxygen gas | 5.00% | by volume |

Each raw material is heated to produce steam, and mixed and diluted with discharge gas and reaction gas having subjected to extra heating in advance so as not to coagulate the raw material, and the raw material was subsequently supplied into the discharge space.

### <Lower Layer Formation Condition>

Power supply on the first electrode side:

High-frequency power supply manufactured
by OYO ELECTRIC Co., Ltd.

| | | |
|---|---|---|
| Frequency | 80 | kHz |
| Power density | 10 | W/cm² |

Power supply on the second electrode side:

High-frequency power supply manufactured
by Pearl Kogyo Co., Ltd.

| | | |
|---|---|---|
| Frequency | 13.56 | MHz |
| Power density | 10 | W/cm² |

### (Formation of Upper Layer)

Next, an upper layer as an inorganic compound layer (surface layer) was formed on the resulting lower layer described above, employing an atmospheric plasma treatment apparatus shown in FIG. 4.

The following upper layer mixed gas composition was used for material to form an upper layer, and the upper layer was formed under the following film formation condition. As a dielectric to coat each of electrodes in an atmospheric plasma treatment apparatus in this case, one on which aluminum having one surface thickness of 1 mm was coated by ceramic spraying was used for both of the facing electrodes. A spacing distance between the electrodes after coating was set to 1 mm. Further, the metal mother material on which a dielectric was coated was in accordance with stainless steel jacket specification including a coating function with cooling water, and cooling was conducted during discharge while controlling electrode temperature with the cooling water to form the second layer (made of SiO₂).

### <The Second Layer Mixed Gas Composition>

| | | |
|---|---|---|
| Discharge gas: Nitrogen gas | 81.95% | by volume |
| Film-forming (raw material) gas: Tetraethoxysilane | 0.05% | by volume |
| Reaction gas: Oxygen gas | 18.00% | by volume |

Each raw material is heated to produce steam, and mixed and diluted with discharge gas and reaction gas having subjected to extra heating in advance so as not to coagulate the raw material, and the raw material was subsequently supplied into the discharge space.

### <Upper Layer Formation Condition>

Power supply on the first electrode side:

High-frequency power supply manufactured
by OYO ELECTRIC Co., Ltd.

| | | |
|---|---|---|
| Frequency | 80 | kHz |
| Power density | 10 | W/cm² |

Power supply on the second electrode side:

High-frequency power supply manufactured
by Pearl Kogyo Co., Ltd.

| | | |
|---|---|---|
| Frequency | 13.56 | MHz |
| Power density | 10 | W/cm² |

Samples No. 302 to No. 324 were also prepared similarly to preparation of Sample No. 301, except that the preparation conditions of the lower layer and the upper layer were changed so as to give thickness, and hardness and elastic modulus as shown in Table 5. In addition, elastic modulus, hardness and thickness indicate the values measured by the same method as in Example 1.

TABLE 5

| | Surface layer | | | | | |
|---|---|---|---|---|---|---|
| | Lower layer | | | Upper layer | | |
| | Thick- | | Elastic | | Hard- | Elastic |
| | ness | Hardness | modulus | Thickness | ness | modulus |
| Sample | (nm) | (GPa) | (GPa) | (nm) | (GPa) | (GPa) |
| 301 | 500 | 0.15 | 0.75 | 30 | 5.0 | 25.0 |
| 302 | 500 | 0.2 | 1.0 | 30 | 5.0 | 25.0 |
| 303 | 500 | 0.5 | 2.5 | 30 | 5.0 | 25.0 |
| 304 | 500 | 1.0 | 5.0 | 30 | 5.0 | 25.0 |
| 305 | 500 | 1.5 | 7.5 | 30 | 5.0 | 25.0 |
| 306 | 500 | 2.0 | 10.0 | 30 | 5.0 | 25.0 |
| 307 | 500 | 2.5 | 12.5 | 30 | 5.0 | 25.0 |
| 308 | 80 | 1.0 | 5.0 | 30 | 5.0 | 25.0 |
| 309 | 100 | 1.0 | 5.0 | 30 | 5.0 | 25.0 |
| 310 | 500 | 1.0 | 5.0 | 30 | 5.0 | 25.0 |
| 311 | 800 | 1.0 | 5.0 | 30 | 5.0 | 25.0 |
| 312 | 1000 | 1.0 | 5.0 | 30 | 5.0 | 25.0 |
| 313 | 1200 | 1.0 | 5.0 | 30 | 5.0 | 25.0 |
| 314 | 500 | 1.0 | 5.0 | 30 | 1.5 | 7.5 |
| 315 | 500 | 1.0 | 5.0 | 30 | 2.0 | 10.0 |
| 316 | 500 | 1.0 | 5.0 | 30 | 5.0 | 25.0 |
| 317 | 500 | 1.0 | 5.0 | 30 | 8.0 | 40.0 |
| 318 | 500 | 1.0 | 5.0 | 30 | 10.0 | 50.0 |
| 319 | 500 | 1.0 | 5.0 | 30 | 12.0 | 60.0 |
| 320 | 500 | 1.0 | 5.0 | 5 | 5.0 | 25.0 |
| 321 | 500 | 1.0 | 5.0 | 10 | 5.0 | 25.0 |
| 322 | 500 | 1.0 | 5.0 | 30 | 5.0 | 25.0 |
| 323 | 500 | 1.0 | 5.0 | 50 | 5.0 | 25.0 |
| 324 | 500 | 1.0 | 5.0 | 60 | 5.0 | 25.0 |

### Evaluation

The resulting samples (No. 301-No. 324) are measured to obtain measured values of transfer efficiency, durability and filming. Results evaluated in accordance with the same evaluation ranks as in Example 1 are shown in Table 6.

TABLE 6

| Sample | Transfer | | | |
|---|---|---|---|---|
| No. | efficiency | Durability | Filming | Remarks |
| 301 | A | C | B | Present invention |
| 302 | A | B | A | Present invention |
| 303 | A | A | A | Present invention |
| 304 | A | A | A | Present invention |
| 305 | A | B | A | Present invention |
| 306 | A | B | A | Present invention |
| 307 | A | C | B | Present invention |
| 308 | A | C | B | Present invention |
| 309 | A | B | A | Present invention |
| 310 | A | A | A | Present invention |
| 311 | A | A | A | Present invention |
| 312 | A | B | A | Present invention |
| 313 | A | C | B | Present invention |
| 314 | A | C | B | Present invention |
| 315 | A | A | A | Present invention |
| 316 | A | A | A | Present invention |
| 317 | A | B | A | Present invention |
| 318 | A | B | A | Present invention |
| 319 | A | C | B | Present invention |
| 320 | A | C | B | Present invention |
| 321 | A | B | A | Present invention |
| 322 | A | A | A | Present invention |
| 323 | A | B | A | Present invention |
| 324 | A | C | B | Present invention |

When preparing an intermediate transfer member having a structure of substrate/elastic layer/surface layer, the surface layer is designed to be composed of an intermediate layer and a hardness layer made of metal oxide as a main component, and excellent performance in transfer efficiency, durability and filming was obtained via preparation within the range where the intermediate layer has a hardness of 0.2-2.0 GPa, an elastic modulus of 1.0-10.0 GPa and a thickness of 100-1000 nm, and the hardness layer has a hardness of 2.0-10.0 GPa, an elastic modulus of 10.0-50.0 GPa and a thickness of 10-50 nm.

### Example 4

### (Preparation of Endless Belt-Shaped Substrate)

The same endless belt-shaped substrates as in Example 1 were prepared.

### (Preparation of Elastic Layer)

Each of endless belt-shaped substrates on which an elastic layer having a thickness of 150 μm was formed by a dip coating method was prepared, similarly to the same method as in the case of endless belt-shaped substrate No. 1-3 and formed thereon, up to an elastic layer in Example 1, except that kinds of material to form elastic layers as shown in Table 7 on the outer circumference of the resulting endless belt-shaped substrate, and the resulting were designated as No. 4-1 to No. 4-6. In addition, the elastic modulus indicates the value measured by the same method as in Example 1.

TABLE 7

| Endless belt-shaped | | |
|---|---|---|
| substrate No. | | Elastic |
| (the substrate and formed | | layer |
| thereon, up to the elastic layer) | Material for elastic layer | (MPa) |
| 4-1 | Chloroprene rubber | 50 |
| 4-2 | Nitrile rubber | 50 |
| 4-3 | Styrene-butadiene rubber | 50 |
| 4 -4 | Silicone rubber | 50 |
| 4-5 | Urethane rubber | 50 |
| 4-6 | Ethylene-propylene copolymer | 50 |

### (Preparation of Intermediate Transfer Member)

### <Formation of Inorganic Compound Layer (Surface Layer)>

Employing an atmospheric plasma CVD manufacturing apparatus shown in FIG. 4, an inorganic compound (silicon oxide) layer having a thickness of 150 nm was formed on an elastic layer of each of the resulting endless belt-shaped substrates No. 4-1 to No. 4-6 on which up to the elastic layer was formed under the same condition as in preparation of an inorganic compound layer (surface layer) in Example 1, and the resulting were designated as Sample Nos. 401 to 406. In addition, thickness indicates the value measured by the same measuring method as described in Example 1.

### Evaluation

The resulting samples (No. 401-No. 406) are measured to obtain measured values of transfer efficiency, durability and filming. Results evaluated in accordance with the same evaluation ranks as in Example 1 are shown in Table 8.

TABLE 8

| | Endless belt-shaped | | | | |
|---|---|---|---|---|---|
| | substrate No. | | | | |
| | (the substrate and | | | | |
| Sample | formed thereon, up | Transfer | | | |
| No. | to the elastic layer) | efficiency | Durability | Filming | Remarks |
| 401 | 4-1 | A | A | A | Present |
| | | | | | invention |
| 402 | 4-2 | A | A | A | Present |
| | | | | | invention |
| 403 | 4-3 | A | A | A | Present |
| | | | | | invention |
| 404 | 4-4 | A | A | A | Present |
| | | | | | invention |
| 405 | 4-5 | A | A | A | Present |
| | | | | | invention |
| 406 | 4-6 | A | A | A | Present |
| | | | | | invention |

Even though material constituting the elastic layer was replaced by any of chloroprene rubber, nitrile rubber, styrene-butadiene rubber, silicone rubber, urethane rubber and an ethylene-propylene copolymer, excellent performance in transfer efficiency, durability and filming was obtained. Effectiveness of the present invention was confirmed.

### Example 5

### (Preparation of Endless Belt-Shaped Substrate)

Endless belt-shaped substrates each containing a conductive material and having a thickness of 100 μm were prepared similarly to the same method as in the case of substrate No. 103 in Example 1, except that the substrate material was replaced by each of those shown in Table 9, and were designated as No. 5-1, No. 5-2 and No. 5-3.

TABLE 9

| Endless belt-shaped | | Elastic layer |
|---|---|---|
| substrate No. | Material | (GMPa) |
| 5-1 | Polycarbonate | 5.0 |
| 5-2 | Polyphenylene sulfide | 5.0 |
| 5-3 | Polyethylene terephthalate | 5.0 |

### (Preparation of Intermediate Transfer Member)

The same elastic layer as in the case of endless belt-shaped substrate No. 1-3 and formed thereon, up to an elastic layer described in Example 1 was formed on each of the resulting endless belt-shaped substrates No. 5-1, No. 5-2 and No. 5-3 by the same method as in the foregoing case. Thereafter, an inorganic compound (silicon oxide) layer having a thickness of 150 nm was formed under the same conditions as in formation of an inorganic compound layer (surface layer) in Example 1 employing an atmospheric plasma CVD manufacturing apparatus as shown in FIG. 4 to prepare an intermediate transfer belt, and the resulting were designated as samples No. 501, No. 502 and No. 503. In addition, layer thickness indicates the value measured by the same measuring method described in Example 1.

### Evaluation

The resulting samples No. 5-1, No. 5-2 and No. 5-3 are measured to obtain measured values of transfer efficiency, durability, paper following capability and filming. Results evaluated in accordance with the same evaluation ranks as in Example 1 are shown in Table 10.

TABLE 10

| | Endless | | | | |
|---|---|---|---|---|---|
| Sample | belt-shaped | Transfer | | | |
| No. | substrate No. | efficiency | Duability | Filming | Remarks |
| 501 | 5-1 | A | A | A | Present invention |
| 502 | 5-2 | A | A | A | Present invention |
| 503 | 5-3 | A | A | A | Present invention |

Even though material constituting the substrate was replaced by any of polycarbonate, polyphenylene sulfide, polyethylene terephthalate, excellent performance in transfer efficiency, durability and filming was obtained. Effectiveness of the present invention was confirmed.

### Example 6

### (Preparation of Endless Belt-Shaped Substrate)

The same endless belt-shaped substrates as in Example 1 were prepared. The same elastic layer as in the case of endless belt-shaped substrate No. 1-3 and formed thereon, up to an elastic layer described in Example 1 was formed on the resulting endless belt-shaped substrate by the same method as in the foregoing case. Then, after varying material as shown in Table 11, an inorganic compound (silicon oxide) layer having a thickness of 150 nm was formed under the same conditions as in formation of an inorganic compound layer (surface layer) in Example 1 employing an atmospheric plasma CVD manufacturing apparatus as shown in FIG. 4 to prepare an intermediate transfer belt, and the resulting were designated as samples No. 601, No. 602, No. 603, No. 604 and No. 605. In addition, hardness, elastic modulus and layer thickness indicate the values measured by the same measuring method described in Example 1.

TABLE 11

| | Surface layer | | | |
|---|---|---|---|---|
| | | | | Ratio of elastic |
| | | | | modulus of surface |
| | | | Elastic | layer to elastic |
| Sample | | Hardness | modulus | modulus of |
| No. | Material | (GPa) | (GPa) | elastic layer |
| 601 | Silicon dioxide | 5 | 25 | 500 |
| 602 | Silicon nitride | 5 | 25 | 500 |
| 603 | Silicon carbide | 5 | 25 | 500 |
| 604 | Silicon nitride-oxide | 5 | 25 | 500 |
| 605 | Silicon nitride-carbide | 5 | 25 | 500 |

### Evaluation

The resulting samples No. 601, No. 602, No. 603, No. 604 and No. 605 are measured to obtain measured values of transfer efficiency, durability and filming. Results evaluated in accordance with the same evaluation ranks as in Example 1 are shown in Table 12.

TABLE 12

| Sample No. | Transfer efficiency | Durability | Filming | Remarks |
|---|---|---|---|---|
| 601 | A | A | A | Present invention |
| 602 | A | A | A | Present invention |
| 603 | A | A | A | Present invention |
| 604 | A | A | A | Present invention |
| 605 | A | A | A | Present invention |

Even though material constituting the substrate was replaced by any of metal oxide, metal nitride and metal oxide-nitride, excellent performance in transfer efficiency, durability and filming was obtained. Effectiveness of the present invention was confirmed.

### EXPLANATION OF NUMERALS

1, 1′ Full-color image forming apparatus
10Y, 10M, 10C, 10K Image forming unit
4′ Transfer unit
401′ Intermediate transfer roller
7 Endless belt-shaped intermediate transfer member unit
70 Intermediate transfer belt
70a Substrate
70b Elastic layer
70c Surface layer
9 Manufacturing apparatus
9a Atmospheric plasma CVD apparatus
9a1 Roll electrode
9a2 Fixed electrode
9a3 Mixed gas supplying device
9a4 Discharge vessel
9a5 High-frequency power supply
9a6 Exhaust tube
9a7 Discharge space
9b Material supplying device

1-9. (canceled)

10. An intermediate transfer member for an electrophotographic image forming apparatus, comprising a support and provided thereon, an elastic layer and a surface layer in this order,
wherein the elastic layer has an elastic modulus of 10-200 MPa, and a thickness of 50-500 μm.

11. The intermediate transfer member of claim 10,
wherein the surface layer has a hardness of 0.2-10 GPa, an elastic modulus of 1.0-50 GPa, a thickness of 100-1000 nm, and a ratio of an elastic modulus of the surface layer to another elastic modulus of the elastic layer is 10-5000.

12. The intermediate transfer member of claim 10,
wherein the surface layer comprises two layers composed of a lower layer and an upper layer, the lower layer having a hardness of 0.2-2.0 GPa, an elastic modulus of 1.0-10.0 GPa and a thickness of 100-1000 μm, the upper layer adjacent to the lower layer, having a hardness of 2.0-10.0 GPa, an elastic modulus of 10.0-50.0 GPa and a thickness of 10-50 nm.

13. The intermediate transfer member of claim 10,
wherein the elastic layer comprises a layer formed of at least one selected from the group consisting of chloroprene rubber, nitrile rubber, styrene-butadiene rubber, silicone rubber, urethane rubber and an ethylene-propylene copolymer.

14. The intermediate transfer member of claim 10,
wherein the substrate comprises at least one selected from the group consisting of polyimide, polycarbonate, polyphenylene sulfide and polyethylene terephthalate.

15. The intermediate transfer member of claim 10,
wherein the surface layer comprises an inorganic compound, the inorganic compound comprising at least one selected from the group consisting of metal oxide, metal nitride and metal oxide-nitride.

16. The intermediate transfer member of claim 15,
wherein the inorganic compound comprises metal oxide, metal nitride or metal oxide-nitride formed from at least one selected from the group consisting of Al, Si and Ti.

17. The intermediate transfer member of claim 15,
wherein the inorganic compound is silicon oxide or silicon oxide comprising a carbon.

18. The intermediate transfer member of claim 10,
wherein the surface layer comprises a layer formed via an atmospheric pressure plasma CVD method
